(19) United States
(12) Patent Application Publication
(10) Pub. No.: US 2011/0179395 A1
(43) Pub. Date: Jul. 21, 2011

(54) Distributed Pipeline Synthesis for High Level Electronic Design

(76) Inventors: Maxim Smirnov, Wilsonville, OR (US); Peter Gutberlet, Wilsonville, OR (US)

(21) Appl. No.: 12/690,811

(22) Filed: Jan. 20, 2010

(51) Int. Cl. G06F 17/50

(52) U.S. Cl. 716/126; 716/100; 716/104

(57) ABSTRACT

High level synthesis techniques are disclosed, particularly, techniques for synthesizing pipelines having distributed control. In some implementations, an algorithmic description for a device design is first identified. Subsequently, a data-flow representation of the algorithmic description is generated; the data-flow representation including a plurality of operations. The plurality of operations are then scheduled, following which, a plurality of pipeline stages are generated corresponding to ones of the plurality of operations. Control logic for the pipeline stages may then be generated, followed by the generation of a netlist representation of the electronic device design based in part upon the scheduling of operations and pipeline stages.

### FIELD OF THE INVENTION

The invention relates to the field of electronic device design. More specifically, various implementations of the invention are directed towards synthesizing electronic designs containing sequential operations.

### BACKGROUND OF THE INVENTION

Today, the design of electronic devices no longer begins with diagramming an electronic circuit. Instead, the design of modern electronic devices, and particularly integrated circuits (“IC's”), often begins at a very high level of abstraction. For example, a design may typically start with a designer creating a specification that describes particular desired functionality. This specification, which may be implemented in C, C++, SystemC, or some other programming language, describes the desired behavior of the device at a high level. Device designs at this level of abstraction are often referred to as “algorithmic designs,” “algorithmic descriptions,” or “electronic system level (“ESL”) designs”. Designers then take this algorithmic design, which may be executable, and create a logical design through a synthesis process. The logical design will often be embodied in a netlist. Frequently, the netlist is a register transfer level (“RTL″) netlist.”

Designs at the register level are often implemented by a hardware description language (“HDL”) such as SystemC, Verilog, SystemVerilog, or Very High speed hardware description language (“VHDL”). A design implemented in HDL describes the operations of the design by defining the flow of signals or the transfer of data between various hardware components within the design. For example, an RTL design describes the interconnection and exchange of signals between hardware registers and the logical operations that are performed on those signals.

Designers subsequently perform a second transformation. This time, the register transfer level design is transformed into a gate level design. Gate level designs, like RTL designs, are also often embodied in a netlist, such as, a mapped netlist for example. Gate level designs describe the gates, such as AND gates, OR gates, and XOR gates that comprise the design, as well as their interconnections. In some cases, a gate level netlist is synthesized directly from an algorithmic description of the design, in effect bypassing the RTL netlist stage described above.

Once a gate level netlist is generated, the design is again taken and further transformations are performed on it. First the gate level design is synthesized into a transistor level design, which describes the actual physical components such as transistors, capacitors, and resistors as well as the interconnections between these physical components. Second, place and route tools then arrange the components described by the transistor level netlist and route connections between the arranged components. Lastly, layout tools are used to generate a mask that can be used to fabricate the electronic device, through for example an optical lithographic process.

In general, the process of generating a lower-level circuit description or representation of an electronic device (such as an RTL netlist or a gate level netlist), from a higher-level description of the electronic device (such as an algorithmic description,) is referred to as “synthesis.” Similarly, a software application used to generate a lower-level design from a higher-level design is often referred to as a “synthesis tool.” One difficulty involved in synthesizing an RTL netlist from an algorithmic design is dealing with “pipelines.” A pipeline is a set of elements, such as finite state machine, connected in series such that the output from one element is the input to another element.

In conventional synthesis, sequential operations in the algorithmic description of the device are synthesized into one or more pipelines comprised of a single finite state machine each, which is incapable of processing individual operations. This prevents the pipeline from flushing. That is, an input to the finite state machine is required during each cycle of operation. Although techniques exist which allow for the representation of pipelines within RTL or gate level netlist that can “flush,” they all require manual modification of the algorithmic description prior to synthesis. This allows for errors to be introduced into the synthesized designs.

### SUMMARY OF THE INVENTION

Various implementations of the invention provide processes and apparatuses for synthesizing a netlist description having a distributed pipeline from an algorithmic description having sequential operations and describing an electronic device design. In some implementations, an algorithmic description for a device design is first identified. Subsequently, a data-flow representation of the algorithmic description is generated; the data-flow representation including a plurality of operations. The plurality of operations are then scheduled, following which, a plurality of pipeline stages are generated corresponding to ones of the plurality of operations. Control logic for the pipeline stages may then be generated, followed by the generation of a netlist representation of the electronic device design based in part upon the scheduling of operations and the generated pipeline stages.

### BRIEF DESCRIPTION OF THE DRAWINGS

The present invention will be described by way of illustrative embodiments shown in the accompanying drawings in which like references denote similar elements, and in which:

FIG. 1 shows an illustrative computing environment;

FIG. 2 illustrates a function definition having sequential operations;

FIG. 3 illustrates a schedule corresponding to the sequential operations from the function definition of FIG. 2;

FIG. 4 illustrates a datapath control finite state machine generated based upon the sequential operations from the function definition of FIG. 2;

FIG. 5 illustrates the schedule of FIG. 3 for multiple iterations;

FIG. 6 illustrates a method of synthesizing a distributed pipeline;

FIG. 7 illustrates a data-flow diagram;

FIG. 8 illustrates a method of forming pipeline stages;

FIG. 9 illustrates a pair of pipeline stages corresponding to the sequential operations from the function definition of FIG. 2;

FIG. 10 illustrates a pipeline stage corresponding to the sequential operations from the function definition of FIG. 2;

FIG. 11 illustrates a distributed pipeline corresponding to the pipelines stages of FIG. 9;

FIG. 12 illustrates a pipeline having decoupling logic;

FIG. 13 illustrates a function defining multi-cycle operations;

FIG. 14 illustrates a schedule corresponding to the function of FIG. 13;

FIG. 15 illustrates a distributed pipeline corresponding to the multi-cycle operations from the function of FIG. 13;

FIG. 16 illustrates a function defining shared operations;

FIG. 17 illustrates a pipeline corresponding to the shared operations from the function of FIG. 16;

FIG. 18 illustrates a function defining looped operations;

FIG. 19 illustrates a distributed pipeline corresponding to the looped operations from the function of FIG. 18;

FIG. 20 illustrates a distributed pipeline generation tool.

### DETAILED DESCRIPTION OF ILLUSTRATIVE EMBODIMENTS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “determine” to describe the disclosed methods. Such terms are often high-level abstractions of the actual operations that are performed. The actual operations that correspond to these terms will often vary depending on the particular implementation, and will be readily discernible by one of ordinary skill in the art.

Furthermore, in various implementations of the invention, a mathematical model may be employed to represent an electronic device. With some implementations, a model describing the connectivity of the device, such as for example a netlist, is employed. Those of skill in the art will appreciate that the models, even mathematical models represent real world device designs and real world physical devices. Accordingly, manipulation of the model, even manipulation of the model when stored on a computer readable medium, results in a different device design. More particularly, manipulation of the model results in a transformation of the corresponding physical design and any physical device rendered or manufactured by the device design. Additionally, those of skill in the art can appreciate that during many electronic design and verification processes, the response of a device design to various signals or inputs is simulated. This simulated response corresponds to the actual physical response the device being modeled would have to these various signals or inputs.

Some of the methods described herein can be implemented by software stored on a computer readable storage medium, or executed on a computer. Accordingly, some of the disclosed methods may be implemented as part of a computer implemented electronic design automation (“EDA”) tool. The selected methods could be executed on a single computer or a computer networked with another computer or computers. For clarity, only those aspects of the software germane to these disclosed methods are described; product details well known in the art are omitted

### Illustrative Computing Environment

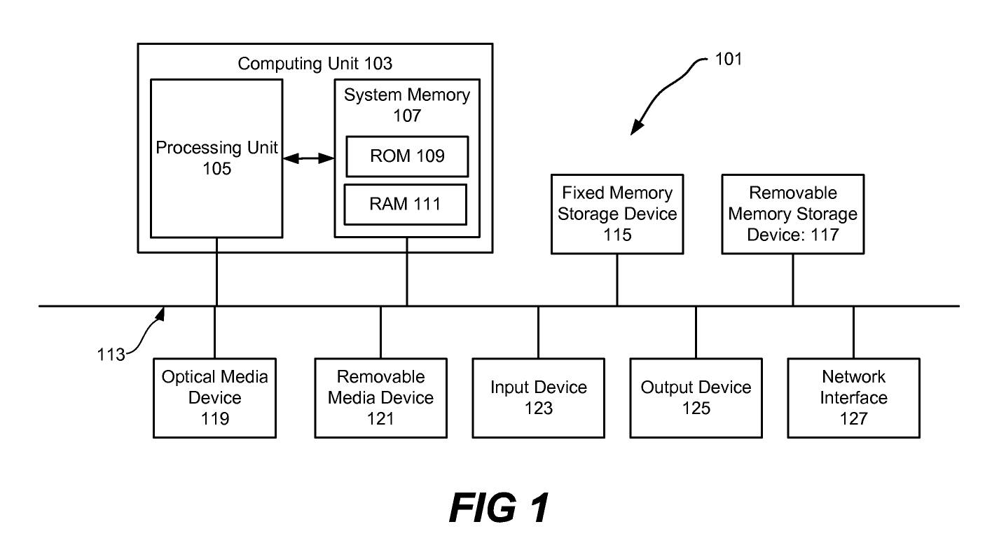

As the techniques of the present invention may be implemented using software instructions, the components and operation of a generic programmable computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (“ROM”) 109 and a random access memory (“RAM”) 111. As will be appreciated by those of ordinary skill in the art, both the ROM 109 and the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### Illustrative Data Pipeline

As stated above, various implementations of the invention are directed towards synthesizing a register transfer level description of an electronic device design containing a distributed pipeline, from an algorithmic description of the electronic device design that includes sequential operations. Accordingly pipelines (sometimes referred to as “data pipelines” or “instruction pipeline”,) are briefly discussed herein. Additionally, algorithmic descriptions having sequential operations are discussed.

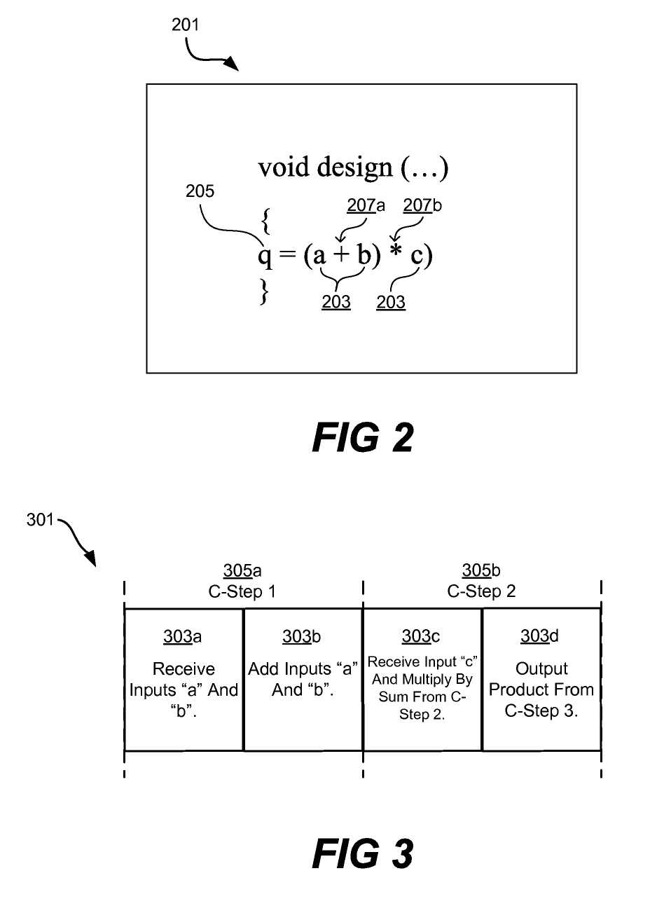

FIG. 2 illustrates a function definition 201 that may be part of an algorithmic description for an electronic device design. As can be seen from this figure, the function definition 201 defines a function titled “design” that adds input 203 “a” and the input 203 “b” together then subsequently multiplies that sum (i.e. the sum of input 203 “a” and input 203 “b”) with an input 203 “c” resulting in the output 205 “q” being derived. As those of skill in the art can appreciate, the input 203 “a” and the input 203 “b” will be needed first. Subsequently, the input 203 “c” along with the sum of the input 203 “a” and the input 203 “b” will be needed. Accordingly, the function definition 201 defines sequential operations 207.

FIG. 3 graphically illustrates a schedule 301 corresponding to the function definition 201. As can be seen from this figure, the schedule 301 includes a plurality of operations 303 performed in discrete steps 305. The steps 305 are often referred to as control steps or C-Steps. The operations 303 each correspond to a particular operation of the function definition 201 of FIG. 2. For example, in the control step 305a the sum of the input 203 “a” and the input 203 “b” is derived, which corresponds to the sequential operations 207a. Additionally, in the control step 305b the sequential operation 207b for multiplying the sum derived in control step 305a and the input 203 “c” is represented. Furthermore, operations, such as the operations 303a for example, for data input and output are represented.

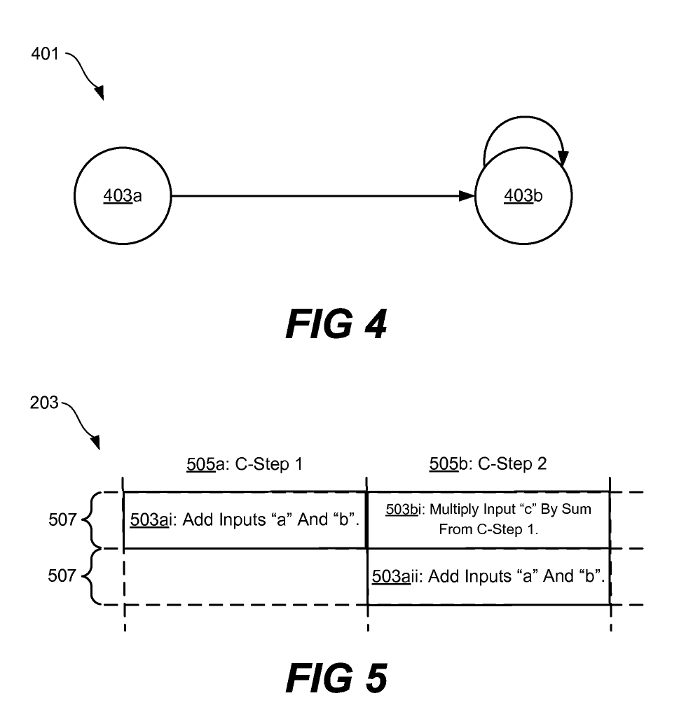

As indicated above, traditional high level synthesis techniques typically apply a centralized approach to synthesizing pipelines. More particularly, an element capable of handling the required number of consecutive operations defined by the schedule is generated. For example, FIG. 4 illustrates a datapath control finite state machine (DPFSM) 401 that may be generated by conventional techniques to represent the schedule 301 and as a result, represent the sequential operations 207 of FIG. 2. As can be seen from FIG. 4, the datapath control finite state machine 401 includes interconnected finite state machines 403. The first finite state machine 403a receives the input 203 “a” and the input 203 “b” and stores the sum of these inputs. While the second finite state machine 403b receives the input 203 “c” and the sum from the first finite state machine 403 a and stores the product.

As those of skill in the art can appreciate, the datapath control finite state machine 401 can process two consecutive transactions, however it has only a single state. Although the conventional method of synthesizing pipelines typically results in relatively compact hardware, the fact that neighboring operations cannot be decoupled presents a major disadvantage to synthesizing electronic designs having pipelined operations.

To clarify this stated disadvantage, FIG. 5 illustrates multiple iterations of the schedule 301 of FIG. 3. As can be seen from FIG. 5, the operations for data input and output have been implicitly incorporated into adjacent control steps. Accordingly, operations 503a and 503b correspond to the addition and multiplication operations respectively (i.e. the sequential operations 207 of FIG. 2,) performed during control steps 505a and 505b. The rows in FIG. 5 represent separate iterations of the operations 503. A first iteration 507 and a second iteration 509 are shown. As described above, conventional pipelines cannot process neighboring operations separately. More particularly, the operation 503bi for the first iteration 507 cannot complete until the input “a” and the input “b” for the second iteration 509 are received. As a result, if data that is needed for a current operation is not available, all operations are stalled, including downstream operations. This inability to decouple adjacent control steps prevents the pipeline from “flushing.”

As briefly mentioned above, a pipeline capable of “flushing” may conventionally be synthesized by first adding enable arguments into the algorithmic description of the design and making the execution of the algorithmic design conditional on the enable arguments. Subsequently, when these enable arguments are synthesized, an enable port will be generated in the register transfer level design. These enable ports may then be used as handshaking inputs to decouple the operations of the pipeline. Although this process provides for the synthesis of pipelines that flush, the synthesized netlists as well as the conventional synthesis processes have many disadvantages.

One disadvantage is that the conventional techniques require the enable arguments (i.e. handshaking code) to be inserted into the algorithmic design prior to synthesis. Often, the handshaking code must be inserted manually by a designer. As the handshaking elements and the data inputs are subject to timing constraints, scheduling errors are often manifest in the synthesized register transfer level design. Additionally, conventional techniques do not work for designs with multi-cycle components or vector inputs. As a result, conventional synthesis techniques do not provide suitable methods for synthesizing pipelines having distributed control.

### Distributed Control Pipeline Synthesis

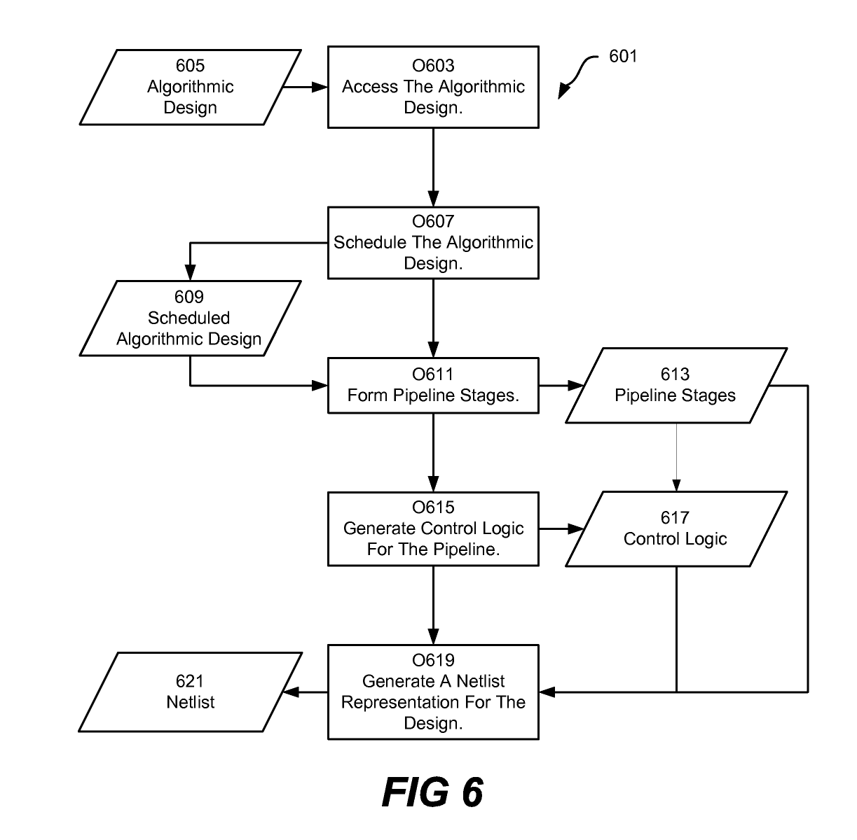

FIG. 6 illustrates a method 601 for synthesizing a distributed pipeline, which may be provided according to various implementations of the present invention. As can be seen from this figure, the method 601 includes: an operation 603 for accessing an algorithmic design 605; an operation 607 for generating a scheduled algorithmic design 609 from the algorithmic design 605; an operation 611 for forming a plurality of pipeline stages 613 from one or more portions of the scheduled algorithmic design 609; and operation 615 for generating control logic 617 for the plurality of pipeline stages 613; and an operation 619 for generating a netlist representation 621 of the pipeline stages 613 and the control logic 617. In various implementations, the algorithmic design 605 is a C program. With some implementations, the algorithmic design 605 is a C++ program. Still, with various implementations, the algorithmic design 605 is a SystemC program.

Scheduling the Algorithmic Design

As described above, an algorithmic device design describes functions and “operations” with which the design should perform. For example, the function definition 201 of FIG. 2 defines the sequential operations 207. In various implementations of the invention, the operation 607 organizes the various operations defined in the algorithmic design 605 into corresponding control steps. This may be facilitated by first generating a data-flow representation of the algorithmic description 605 and subsequently assigning operations to control steps based upon the placement of the operations in the data-flow representation.

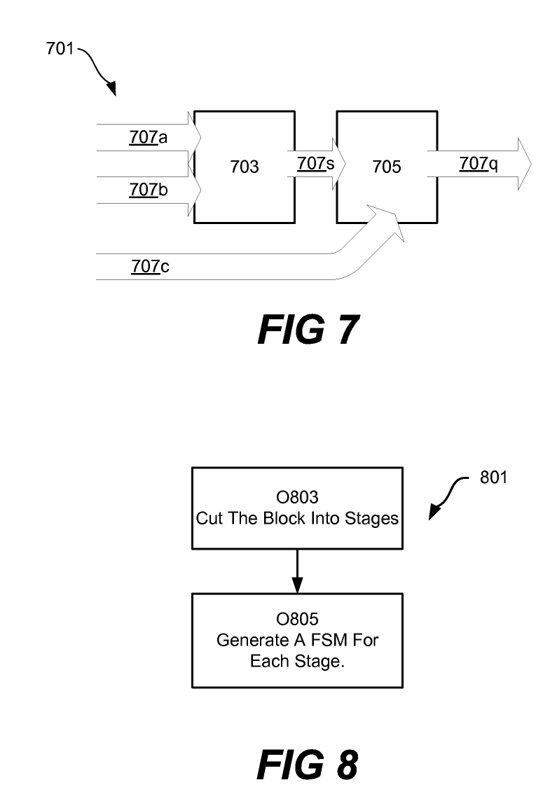

For example, FIG. 7 illustrates a data-flow representation 701 corresponding to the function definition 201 illustrated in FIG. 2. As can be seen from FIG. 7, the data-flow representation 701 includes a first operation 703, a second operation 705, and data 707. As shown, data 707a and 707b flows into (i.e. as input) the first operation 703, while data 707c and 707s flows into the second operation. While data 707s and 707q flows from (i.e. as output) the first operation 703 and the second operation 705 respectively. Accordingly, as illustrated, the first operation 703 and the second operation 705 can not be completed in the same cycle as the second operation 705 requires the data 707s which is only available once the first operation 703 has completed.

In various implementations, the data-flow representation may be graphical, as illustrated in FIG. 7. Alternatively, with some implementations, the data-flow representation is a state diagram for the algorithmic design 605. Still, in some implementations, the data-flow diagram is logical representation of the algorithmic design 605, such as, for example a graph or a flow chart. As stated, the sequential operations may be subsequently assigned to control steps based upon the data-flow representation. For example, the data-flow representation 701 reveals that the first operation 703 and the second operation 705 must occur in different cycles. Accordingly, they could each be assigned or scheduled during separate control steps.

Scheduling in the context of high level synthesis, and particularly, scheduling methods that may be utilized by various implementations of the present invention are discussed in detail in Automatic Module Allocation in High Level Synthesis, by P. Gutberlet et al., Proceeding of the Conference on European Design Automation, pp. 328-333, 1992, CASCH-A Scheduling Algorithm for High Level Synthesis, by P. Gutberlet et al., Proceeding of the Conference on European Design Automation, pp. 311-315, 1991, A Formal Approach to the Scheduling Problem in High Level Synthesis, by Cheng-Tsung Hwang et al., IEEE Transaction on Computer-Aided Design, Vol. 10 No. 4 pp. 464-475, April 1991, and Force-Drected Scheduling for the Behavioral Synthesis of ASICs, by P. G. Paulin et al., IEEE Transaction on Computer-Aided Design of Integrated Circuits and Systems, Vol. 8 No. 6 pp. 661-679, June 1989, which articles are all incorporated entirely herein by reference.

Forming the Pipeline Stages

Returning to FIG. 6, as shown, the method 601 includes the operation 611 for forming pipeline stages 613 from the scheduled algorithmic design 609. In various implementations of the invention, the operation 611 takes a portion of the scheduled algorithmic design 609 and partitions the portion of the scheduled algorithmic design 609 into pipeline stages. As used herein, the portion of the scheduled algorithmic design 609 to be partitioned may be referred to as a block. For example, FIG. 3 illustrates the schedule 301, or block, which corresponds to the function definition 201.

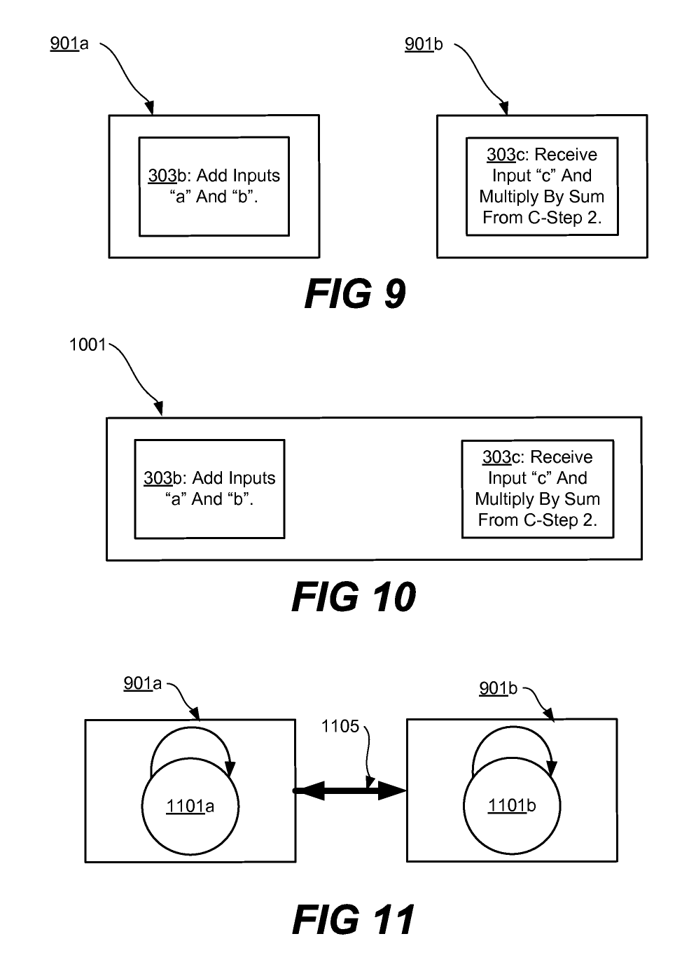

FIG. 8 illustrates a method 801 for cutting a scheduled algorithmic design. In various implementations, the operation 611 performs the method 801 shown in FIG. 8. As can be seen from this figure, the method 801 includes an operation 803 for cutting a block into stages and an operation 805 for generating a finite state machine representation for each stage. With various implementations, the operation 803 for cutting the block into stages may “cut” or partition between each controls step. For example, the schedule 301 of FIG. 3 may be cut between each respective control step 305. In further implementations, the operations for receiving and outputting data may be incorporated into adjacent control steps, as indicated above. As such, the schedule 301 may be cut into stages 901 illustrated in FIG. 9. As can be seen from this figure, the stages 901 each include the operations from a single control step 305. Particularly, the stage 901a includes the operation 303b and the stage 901b includes the operation 303c.

In various implementations, the operations 803 cuts the block between each control step, as illustrated in FIG. 9. With some implementations, the operation 803 may cut the block between every n^{th} control step. As used herein, n represent an initiation interval. For example, FIG. 10 illustrates a pipeline stage 1001, which corresponds to the schedule 301. As can be seen from this figure, the pipeline state 1001 was formed with an initiation interval of 2. As evidenced by the pipeline stage containing the operations 303b and 303c, which occur in adjacent control steps 305b and 305c respectively. In some implementations, the initiation interval is given by a user of the implementation.

Returning to FIG. 8, the method 801 includes the operation 805 for forming a finite state machine for each stage. In various implementations, the operation 805 will generate data-path finite state machines. For example, FIG. 11 illustrates the pipeline stages 901 of FIG. 9, and data-path finite state machines 1101 corresponding to the operations 303b and 303c of the schedule 301 of FIG. 3 corresponding to the pipeline stages 901.

Generating the Control Logic

Returning to FIG. 6, the method 601 includes the operation 615 for generating control logic 617 for the pipeline stages 613. In various implementations, the operation 615 generates handshaking ports and signals for each pipeline stage. For example, FIG. 11 illustrates control logic 1105 that connects the pipeline stage 901a to the pipeline stage 901b. In various implementations, the control logic 617 will include return path between pipeline stages. The return path facilitates cases where an output is unable to receive data preventing intermediate results from each stage of the pipeline from passing from element to element. With further implementations, a decoupling pipe may be inserted between selected pipeline stages 613.

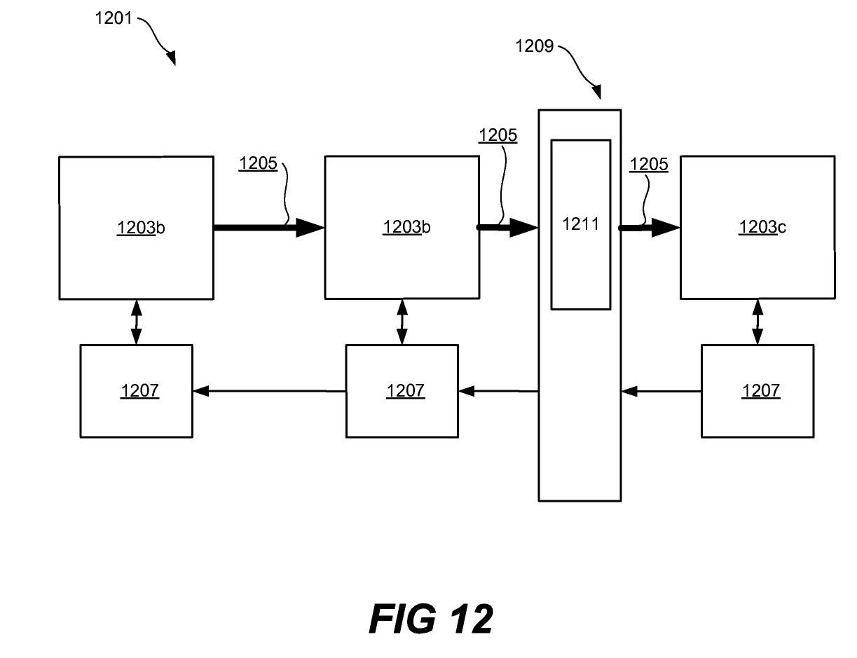

FIG. 12 illustrates a pipeline 1201 including pipeline stages 1203, control logic 1205, return path 1207, and decoupling pipe 1209. As can be seen from this figure, the decoupling pipe 1209 has been inserted between the pipeline stage 1203b and the pipeline stage 1203c. The decoupling pipe, as stated, allows for a reduction in the back-pressure between the pipeline stages 1203. More particularly, when an output is blocked, for example by a full storage register, the intermediate result from each stage is pushed back via the return path. However, the decoupling pipe 1209 allows for the storage of an intermediate result, thereby releasing the back-pressure. This provides for an reduction in the fanout. In various implementations, the number of pipeline stages between a decoupling pipe is selected by the user. With further implementations, a decoupling pipe may be inserted at the input or output of the design, for example to facilitate data buffering.

Generating the Netlist Representation of the Electronic Design

Returning to FIG. 6, the method 601 includes the operation 619 for generating a netlist representation for the pipeline stages 613 and the control logic 617. In various implementations, the operation 619 selects a component for each pipeline stage 613 based upon a library of components. With some implementations, the netlist representation 621 is a register transfer level netlist. As such, the library may be a library of register transfer level components.

Distributed Pipeline Generation for Multi-Cycle Operations

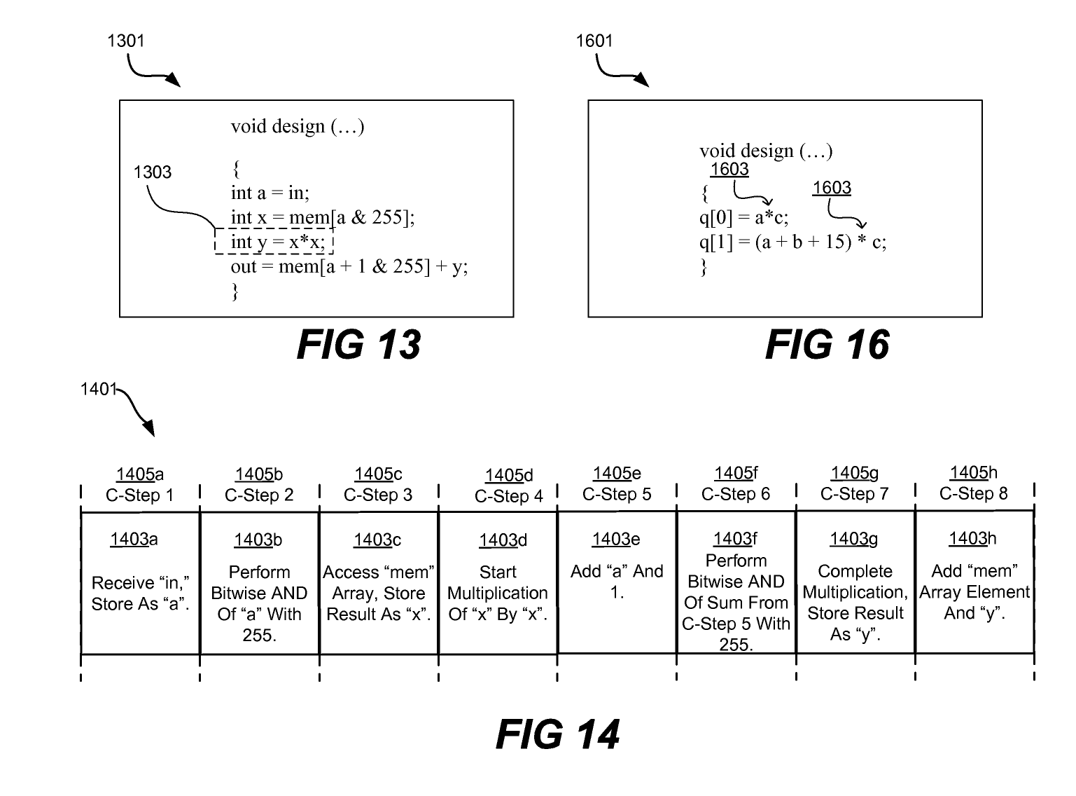

The method 601 may be applied to an algorithmic description 605 that includes multi-cycle operations. A multi-cycle operation is an operation that is scheduled to be completed in multiple control steps. For example, FIG. 13 illustrates a function 1301 that defines a pipeline having a multi-cycle operation. Namely, the multiplication operation 1303. More particularly, as illustrated in FIG. 14 by the schedule 1401 that corresponds to the function 1301. As can be seen from this figure, the multiplication operands for the multi-cycle operation 1303 are available during the control step 1405d, as indicated by the operation 1403d, which initiates the multiplication operation. However, the product of the multiplication operation is not available until the operation 1403e has completed during the control step 1405e.

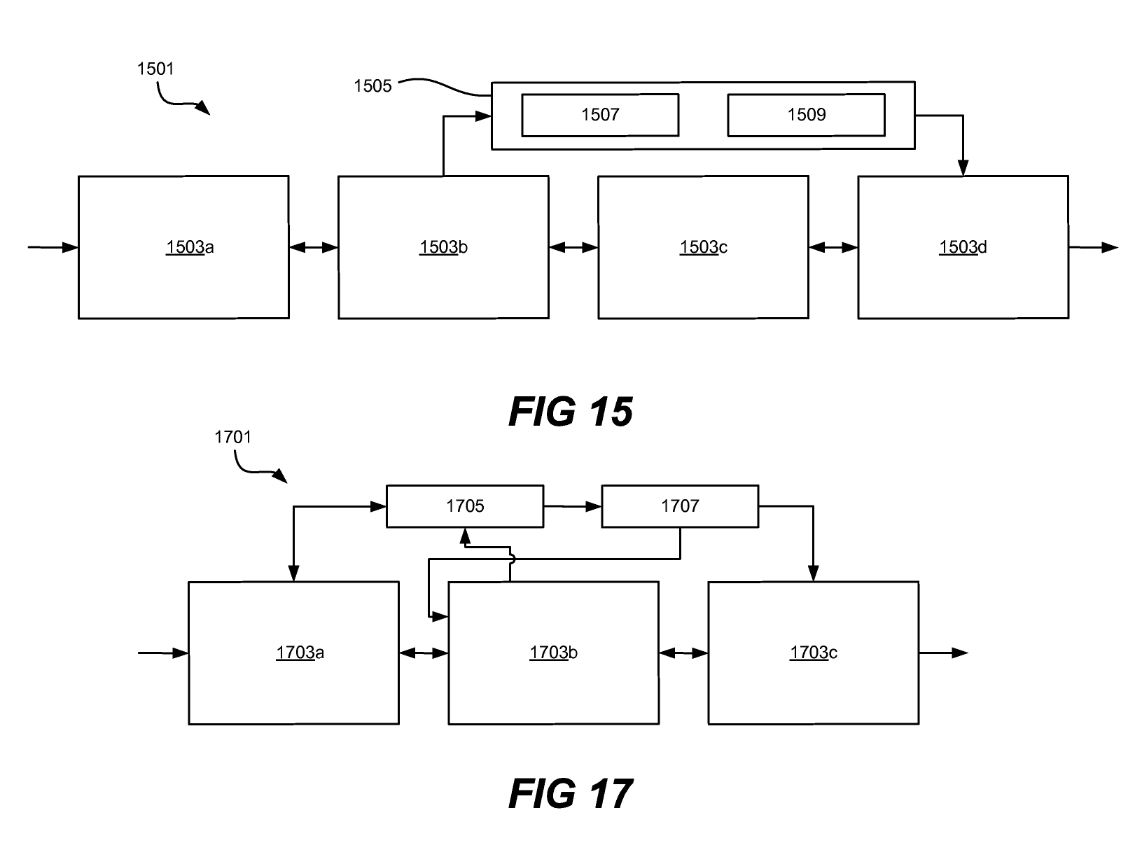

FIG. 15 illustrates a pipeline 1501, generated based upon the schedule 1401 and an initiation interval of two. As can be seen from this figure, the pipeline 1501 includes four pipeline stages 1503 and a wrapper 1505. The wrapper 1505 includes a multi-cycle operation module 1507 and a storage module 1509. The multi-cycle operation module 1507 will be logic that corresponds to the multi-cycle operation. For example, logic facilitating a multiplication operation in this case. In various implementations, the storage module 1509 will be a storage register. In various implementations, multi-cycle operations may be mapped to a single pipeline stage in which case, the pipeline would not need a wrapper.

Distributed Pipeline Generation for Shared Operations

The method 601 may also be applied to an algorithmic description 605 that includes shared operations. A shared operation is an operation that is used multiple times. For example, FIG. 16 illustrates a function 1601, including shareable operations 1603. FIG. 17 shows a pipeline 1701 that may be generated by various implementations of the invention to correspond to the function 1601. As can be seen from FIG. 17, the pipeline 1701 includes three pipeline stages 1703, arbiters 1705 and a shared component 1707. It is important to note, that a single shared component 1707 is able to perform both shareable operations 1603 from the function 1601.

In various implementations, the shared component 1707 will not have a state. For example, dataflow components often do not have a state. Contrast this with input/output components, memories and user operations, which often do have a state. With some implementations, the arbiter 1705 provides synchronization between the pipeline stages 1703 that share the shared component 1707. These types of arbiters are often referred to as “blocking” arbiters. With alternative implementations, the arbiter 1705 is a multiplexer. This type of arbiter is referred to as a “non-blocking” arbiter. These types of arbiters may be used where it is assumed that the pipeline stages 1703 that share the shared component 1707 are synchronized with other means, for example through control logic. With some implementations, a priority may be assigned to particular pipeline stages 1703. For example, pipeline stages 1703 closer to the end of the pipeline 1701 may be assigned a higher priority to assist in avoiding deadlocks in the pipeline arbitration policy.

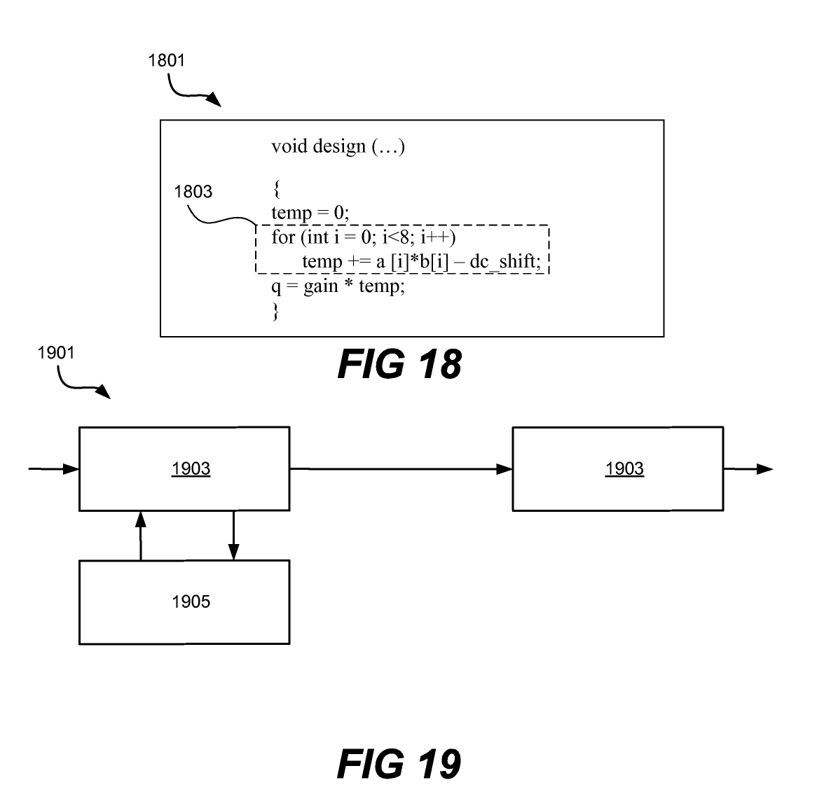

Various implementations of the invention are applicable to algorithmic designs having loops. For example, FIG. 18 shows a function 1801 that defines a loop 1803. In various implementations, a loop may be “flattened” during generation of the pipeline stages. For example, an infinite loop is a loop that has no exit statements. As such, the loop has a single sequence of potential conditional statements. Since the infinite loop never exits (due to there not being any exit statements,) all statements before the loop are referred to as initialization operations. In various implementations, the initialization operations are included in the first stage of the pipeline corresponding to the loop. With further implementations, the statements after the loop are optimized away. Meaning the operations corresponding to the statements are not included in the pipeline.

In various implementations, subsequent pipeline stages are generated that correspond to the separate operations within the loop. With some implementations, a slave stage may be created to correspond to the loop. For example, FIG. 19 illustrates a pipeline 1901 that corresponds to the function 1801 and the loop 1803. As can be seen from this figure, the pipeline 1901 includes two pipeline stages 1903, and a slave stage 1905. In various implementations, the slave stage 1905 will be a data-path finite stage machine that corresponds to the operations within the loop. For example, in this case, the slave stage 1905 may be generated to derive the product of the array elements “a[i]” and “b[i],” less the variable “dc_shift,” and assign the sum of this value and the variable “temp” to the variable “temp.” With further implementations, the slave stage 1905 may itself be a pipeline.

Distributed Pipeline Generation Tool

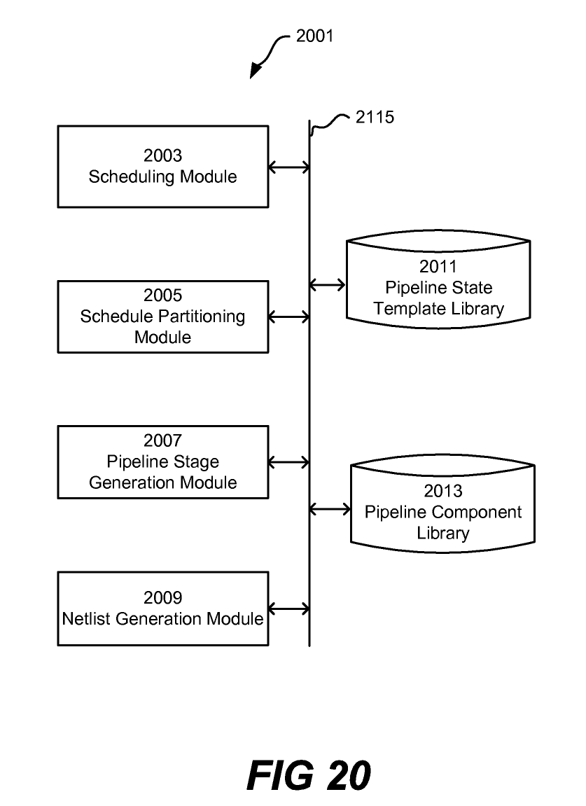

FIG. 20 illustrates a tool 2001 that may be provided by various implementations of the present invention. As can be seen from this figure, the tool 2001 includes a scheduling module 2003, a schedule partitioning module 2005, a pipeline stage generation module 2007, a netlist generation module 2009, a pipeline stage template library 2011, and a pipeline component library 2013. The modules and libraries are interconnected via a bus 2115.

### CONCLUSION

Various methods and tools for synthesizing a netlist description of an electronic device design, from an algorithmic description of the device design having sequential operations, have been disclosed. As stated, with some implementations, an algorithmic description for a device design is first identified. Subsequently, a data-flow representation of the algorithmic description is generated; the data-flow representation including a plurality of operations. The plurality of operations are then scheduled, following which, a plurality of pipeline stages are generated corresponding to ones of the plurality of operations. Control logic for the pipeline stages may then be generated, followed by the generation of a netlist representation of the electronic device design based in part upon the scheduling of operations and pipeline stages.

Although certain devices and methods have been described above in terms of the illustrative embodiments, the person of ordinary skill in the art will recognize that other embodiments, examples, substitutions, modifications and alterations are possible. It is intended that the following claims cover such other embodiments, examples, substitutions, modifications and alterations within the spirit and scope of the claims.

What is claimed is:

1. A computer-implemented method for synthesizing an electronic device design comprising:
accessing an untimed algorithmic description for an electronic device design, the untimed algorithmic description having a plurality of operations;
scheduling the plurality of operations;
forming a plurality of pipeline stages from ones of the scheduled plurality of operations;
generating control logic for the plurality of pipeline stages; and
generating a netlist representation for the electronic device design, the netlist representation including the plurality of pipeline stages and the control logic.

2. The computer-implemented method recited in claim 1, further comprising storing the netlist representation for the electronic device design on one or more computer-readable medium.

3. The computer-implemented method recited in claim 2, the method act for forming the plurality of pipeline stages comprising:
identifying ones of the plurality of operations that are sequential; and
partitioning the ones of the scheduled plurality of operations corresponding to the identified ones of the plurality of operations that are sequential into pipeline stages.

4. The computer-implemented method recited in claim 3, further comprising generating a plurality of finite state machine representations for the plurality of pipeline stages.

5. The computer-implemented method recited in claim 4, the method act of generating control logic for the plurality of pipeline stages comprising:
generating synchronization signals for the plurality of finite state machine representations; and
generating handshaking signals for the plurality of finite state machine representations.

6. The computer-implemented method recited in claim 5, the method act of generating control logic for the plurality of pipeline stages further comprising generating decoupling logic for the plurality of finite state machine representations.

7. The computer-implemented method recited in claim 6, wherein each pipeline stage includes a one of the identified ones of the plurality of operations that are sequential.

8. The computer-implemented method recited in claim 1, the method act of generating a netlist representation for the electronic device design comprising mapping the plurality of pipeline stages to a plurality of electronic components based in part upon a component library.

9. The computer-implemented method recited in claim 8, wherein the netlist representation for the electronic device design is a register transfer level netlist.

10. The computer-implemented method recited in claim 1, wherein the netlist representation for the electronic device design is a gate-level netlist.

11. The computer-implemented method recited in claim 1, wherein the untimed algorithmic description is a sequential C description of the electronic device design.

12. The computer-implemented method recited in claim 1, wherein the untimed algorithmic description is a sequential C++ description of the electronic device design.

13. The computer-implemented method recited in claim 1, wherein the untimed algorithmic description is a sequential SystemC description of the electronic device design.

14. The computer-implemented method recited in claim 1, wherein ones of the identified ones of the plurality of operations that are sequential are multi-cycle operations, and the method act of forming a plurality of pipeline stages from ones of the scheduled operations comprises generating a wrapper connecting the pipeline stages corresponding to the multi-cycle operations.

15. The computer-implemented method recited in claim 14, the wrapper comprising:
a storage register; and
a multi-cycle operation module.

16. The computer-implemented method recited in claim 1, wherein ones of the identified ones of the plurality of operations that are sequential are shared operations, and the method act of forming a plurality of pipeline stages from ones of the scheduled operations comprises:
generating a shared component representing the shared operation; and
generating an arbiter connecting ones of the plurality pipeline stages corresponding to the shared operations and the shared component.

17. The computer-implemented method recited in claim 1, wherein ones of the identified ones of the plurality of operations that are sequential are looped operations, and the method act of forming a plurality of pipeline stages from ones of the scheduled operations comprises forming one or more pipeline slave stages corresponding to the looped operations.

18. The computer-implemented method recited in claim 1, the method act of scheduling the plurality of operations comprising:
generating a data-flow representation for the untimed algorithmic description; and
scheduling the plurality of operations based in part upon the data-flow representation.

19. One or more tangible computer readable media, having a set of instructions executable by at least one computer processor for synthesizing an electronic device design stored thereon, the set of instructions comprising:
accessing an untimed algorithmic description for an electronic device design, the untimed algorithmic description having a plurality of operations;
scheduling the plurality of operations;
forming a plurality of pipeline stages from ones of the scheduled plurality of operations;
generating control logic for the plurality of pipeline stages; and
generating a netlist representation for the electronic device design, the netlist representation including the plurality of pipeline stages and the control logic.

20. The one or more tangible computer readable media recited in claim 19, the set of instructions further comprising storing the netlist representation for the electronic device design on one or more computer-readable medium.

21. The one or more tangible computer readable media recited in claim 20, the instruction for forming the plurality of pipeline stages comprising:
identifying ones of the plurality of operations that are sequential; and
partitioning the ones of the scheduled plurality of operations corresponding to the identified ones of the plurality of operations that are sequential into pipeline stages.

22. The one or more tangible computer readable media recited in claim 21, the set of instructions further comprising generating a plurality of finite state machine representations for the plurality of pipeline stages.

23. The one or more tangible computer readable media recited in claim 22, the instruction for generating control logic for the plurality of pipeline stages comprising:
generating synchronization signals for the plurality of finite state machine representations; and
generating handshaking signals for the plurality of finite state machine representations.

24. The one or more tangible computer readable media recited in claim 23, the instruction for generating control logic for the plurality of pipeline stages further comprising generating decoupling logic for the plurality of finite state machine representations.

25. The one or more tangible computer readable media recited in claim 24, wherein each pipeline stage includes a one of the identified ones of the plurality of operations that are sequential.

26. The one or more tangible computer readable media recited in claim 19, the instruction for generating a netlist representation for the electronic device design comprising mapping the plurality of pipeline stages to a plurality of electronic components based in part upon a component library.

27. The one or more tangible computer readable media recited in claim 26, wherein the netlist representation for the electronic device design is a register transfer level netlist.

28. The one or more tangible computer readable media recited in claim 19, wherein the netlist representation for the electronic device design is a gate-level netlist.

29. The one or more tangible computer readable media recited in claim 19, wherein the untimed algorithmic description is a sequential C description of the electronic device design.

30. The one or more tangible computer readable media recited in claim 19, wherein the untimed algorithmic description is a sequential C++ description of the electronic device design.

31. The one or more tangible computer readable media recited in claim 19, wherein the untimed algorithmic description is a sequential SystemC description of the electronic device design.

32. The one or more tangible computer readable media recited in claim 19, wherein ones of the identified ones of the plurality of operations that are sequential are multi-cycle operations, and the instruction for forming a plurality of pipeline stages from ones of the scheduled operations comprises generating a wrapper connecting the pipeline stages corresponding to the multi-cycle operations.

33. The one or more tangible computer readable media recited in claim 32, the wrapper comprising:
a storage register; and
a multi-cycle operation module.

34. The one or more tangible computer readable media recited in claim 19, wherein ones of the identified ones of the plurality of operations that are sequential are shared operations, and the instruction for forming a plurality of pipeline stages from ones of the scheduled operations comprises:
generating a shared component representing the shared operation; and
generating an arbiter connecting ones of the plurality pipeline stages corresponding to the shared operations and the shared component.

35. The one or more tangible computer readable media recited in claim 19, wherein ones of the identified ones of the plurality of operations that are sequential are looped operations, and the instruction for forming a plurality of pipeline stages from ones of the scheduled operations comprises forming one or more pipeline slave stages corresponding to the looped operations.

36. The one or more tangible computer readable media recited in claim 19, the instruction for scheduling the plurality of operations comprising:
generating a data-flow representation for the untimed algorithmic description; and
scheduling the plurality of operations based in part upon the data-flow representation.

37. A high level synthesis tool for generating distributedly controlled pipelines comprising:
a module for accessing an untimed algorithmic description for an electronic device design, the untimed algorithmic description having a plurality of operations, and ones of the plurality of operations being sequential;
a module for scheduling the plurality of operations;
a pipeline template library;
a module for forming a plurality of pipeline stages from ones of the scheduled plurality of operations that are sequential based in part upon the pipeline template library;
a module for generating control logic for the plurality of pipeline stages based in part upon the pipeline template library;
a pipeline component library; and
a module for generating a netlist representation for the electronic device design, the netlist representation including the plurality of pipeline stages and the control logic.
